(19) United States
(12) Patent Application Publication
(10) Pub. No.: US 2010/0308684 A1
(43) Pub. Date: Dec. 9, 2010

(54) Motor with Detacthable Winding Assemblies

(76) Inventors: Alex Horng, Kaohsiung (TW); Tso-Kuo Yin, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/860,053

(22) Filed: Aug. 20, 2010

Related U.S. Application Data
(63) Continuation-in-part of application No. 12/016,339, filed on Jan. 18, 2008.

(51) Int. Cl. H02K 3/18

(52) U.S. Cl. 310/208

(57) ABSTRACT

A motor with detachable winding assemblies includes a motor base, a shaft tube, a driving circuit board, a shaft, a plurality of winding assemblies and a rotor. Each winding assembly includes a base, a winding, a packaging body and two electrical connection members. The base includes a supporting face. The winding includes two ends and a plane, wherein the plane is in intimate contact with the support face of the base. The packaging body encloses the base and the winding. The two electrical connection members are respectively connected with the driving circuit board and the two ends of the winding, wherein each of the electrical connection members is partially exposed outside the packaging body. The rotor is rotatably coupled to the shaft.

This is a continuation-in-part application of U.S. patent application Ser. No. 12/016,339 filed on Jan. 18, 2008.

### BACKGROUND OF THE INVENTION

1. Field of the Invention

The present invention generally relates to a motor with winding assemblies and, more particularly, to a motor with detachable winding assemblies.

2. Description of Related Art

Referring to FIG. 1, U.S. Pat. No. 4,658,162 discloses a conventional motor including a printed coil unit 9 consisting of a plurality of printed coils 91. In the conventional motor, the printed coil unit 9 has a fixed number of printed coils 91. This causes inconvenience when designing motors, as different motors require different number of the printed coils 91. For example, when designing a double-phased motor, two printed coils 91 should be used. Similarly, when designing a triple-phased motor, three printed coils 91 should be used. The number of the printed coils 91 should be flexibly changed as desired based on design requirement, which can not be satisfied by the conventional motor shown in FIG. 1.

Besides, if one of the printed coils 91 has broken during operation of the motor, the whole printed coil unit 9 will need to be replaced rather than only the broken printed coil 91, resulting in inconvenience in repair.

### SUMMARY OF THE INVENTION

An object of the present invention is to provide a motor with detachable winding assemblies which allow easy repair of the motor.

The invention discloses a motor with detachable winding assemblies, comprising a motor base, a shaft tube, a driving circuit board, a shaft, a plurality of winding assemblies and a rotor. Each winding assembly includes a base, a winding, a packaging body and two electrical connection members. The base includes a supporting face. The winding includes two ends and a plane, wherein the plane is in intimate contact with the support face of the base. The packaging body encloses the base and the winding. The two electrical connection members are respectively connected with the driving circuit board and the two ends of the winding, wherein each of the electrical connection members is partially exposed outside the packaging body. The rotor is rotatably coupled to the shaft.

Furthermore, the invention discloses a motor with detachable winding assembly, comprising a motor base, a shaft tube, a driving circuit board, a shaft, a winding assembly and a rotor. The winding assembly includes a base, a winding, a packaging body, two electrical connection members and an assembling hole. The base includes a supporting face. The winding includes two ends and a plane, wherein the plane is in intimate contact with the support face of the base. The packaging body encloses the base and the winding. The two electrical connection members are respectively connected with the driving circuit board and the two ends of the winding, wherein each of the electrical connection members is partially exposed outside the packaging body. The assembling hole extends through the winding, the base, and the packaging body and is perpendicular to the support face of the base. The rotor is rotatably coupled to the shaft.

Other objects, advantages and novel features of this invention will become more apparent from the following detailed description when taken in conjunction with the accompanying drawings.

### BRIEF DESCRIPTION OF THE DRAWINGS

FIG. 1 shows a perspective view of a conventional motor.

FIG. 2 shows an exploded perspective view of an axial gap type motor with detachable winding assemblies according to a first embodiment of the invention.

FIG. 3 shows a perspective view of a winding assembly according to the first embodiment of the invention.

FIG. 4 shows a cross-sectional view of the winding assembly of FIG. 3.

FIG. 5 shows an exploded view of a radial gap type motor with detachable winding assemblies according to a second embodiment of the invention.

FIG. 6 shows a perspective view of a winding assembly according to the second embodiment of the invention.

FIG. 7 shows a perspective view of a winding assembly for a motor according to a third embodiment of the invention.

FIG. 8 shows an exploded view of an axial gap type motor utilizing the winding assembly of FIG. 7.

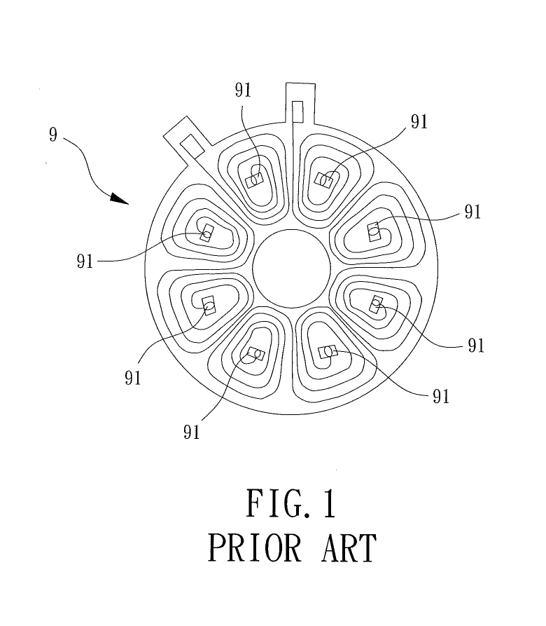

### DETAILED DESCRIPTION OF THE PREFERRED EMBODIMENTS

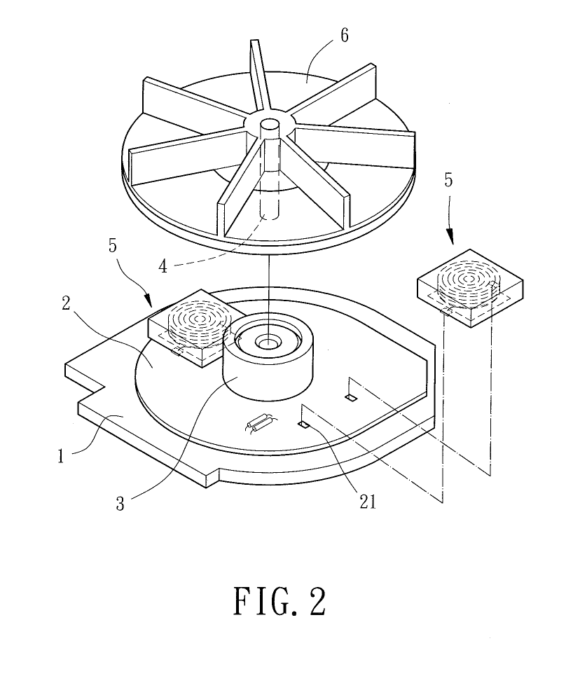

Referring to FIG. 2, an exploded perspective view of an axial gap type motor of a first embodiment is shown according to the preferred teachings of the present invention. The motor includes a motor base 1, a driving circuit board 2, a shaft tube 3, a shaft 4, a plurality of winding assemblies 5 and a rotor 6. The driving circuit board 2 is mounted on the motor base 1. The shaft tube 3 has one end coupled to the motor base 1. The shaft 4 is received in the shaft tube 3. The winding assemblies 5 are detachably mounted on the driving circuit board 2. Specifically, each winding assembly 5 is mounted on the driving circuit board 2 through a pair of electrical connections 21 of the driving circuit board 2. The rotor 6 is rotatably coupled to the shaft 4.

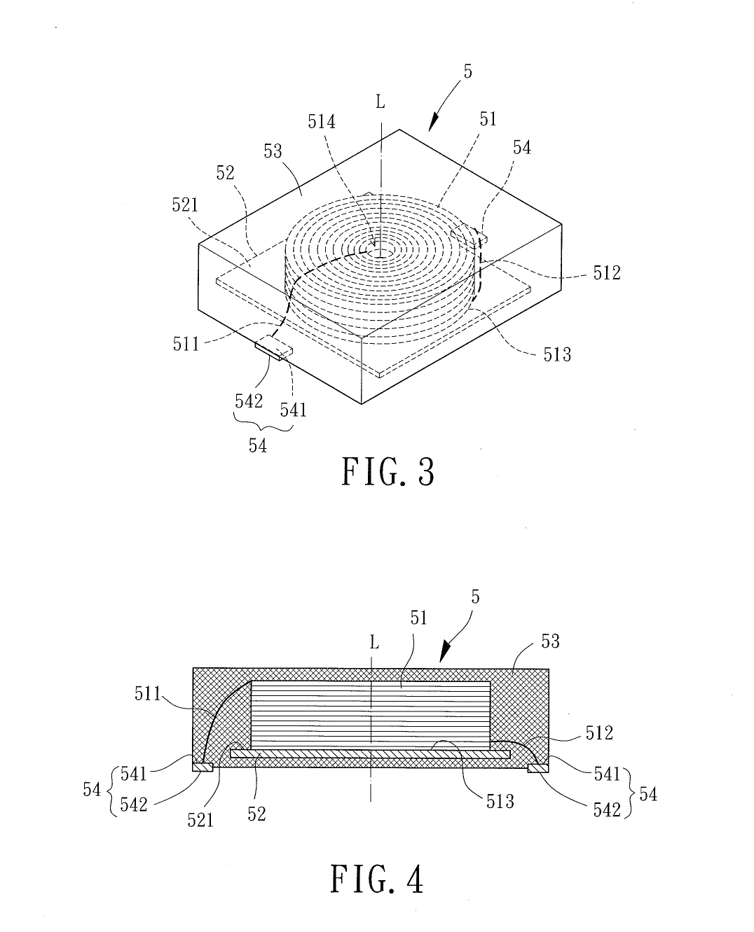

A winding assembly 5 of the motor is shown in FIGS. 3 and 4. The winding assembly 5 includes a winding 51, a base 52, a packaging body 53, and a pair of electrical connection members 54. The winding 51 is formed by winding a conductive wire about an axis L and includes two ends 511 and 512, a plane 513 perpendicular to the axis L, and a central hole 514 extending throughout the winding 51 and perpendicular to the plane 513. The winding direction of the winding 51 can be clockwise or counterclockwise according to the direction of the magnetic field (i.e., the outflow and inflow directions of the sole and north poles) to be created.

Still referring to FIGS. 3 and 4, the base 52 of the winding assembly 5 of the first embodiment according to the preferred teachings of the present invention can be a non-metal plate or a metal plate and includes a supporting face 521 in intimate contact with the plane 513 of the winding 51. The packaging body 53 encloses the winding 51 and the base 52. The packaging body 53 is made of a non-magnetically conductive, non-electrically conductive material such as a packaging gel made of epoxy resin. The supporting face 521 is parallel to the plane 513 and perpendicular to the axis L. By such an arrangement, the positioning effect and the supporting effect of the winding 51 and the base 52 packaged in the packaging body 53 are enhanced.

As can be seen from FIGS. 3 and 4, the winding 51 and the base 52 are enclosed in the packaging body 53 and, thus, not exposed, avoiding damage to the insulation varnish covering the winding 51 and, thus, avoiding short-circuit of the winding 51. Furthermore, the winding 51 is isolated from ambient air, avoiding aging of the winding 51 resulting from oxidization and assuring reliable electrical connection.

Still referring to FIGS. 3 and 4, the electrical connection members 54 of the winding assembly 5 of the first embodiment according to the preferred teachings of the present invention are made of an electrically conductive material such as copper or silver. The electrical connection members 54 are respectively connected to the ends 511 and 512 of the winding 51 and partially exposed outside the packaging body 53. Specifically, as can be seen from FIG. 4, each electrical connection member 54 includes an inner connecting portion 541 in the packaging body 53 and connected to one of the ends 511 and 512 of the winding 51. Each electrical connection member 54 further includes an outer connecting portion 542 disposed at a face of the packaging body 53 for electrical connection with peripheral circuits, with the face preferably being parallel to the base 52 as shown in FIG. 4. Current can be fed to the winding through the outer connecting portions 542 of the electrical connection members 54 to energize the winding 51 for creating a magnetic field. A test can be carried out on the winding assembly 5 to find out the positive and negative poles of the winding assembly 5. Marks indicating the positive and negative poles of the winding assembly 5 can be provided adjacent the outer connecting portions 542 for easy identification by a worker when proceeding with electrical connection with the peripheral circuits.

The outer connecting portions 542 of the electrical connection members 54 of the winding assembly 5 are connected with two electrical connections 21 of the driving circuit board 2 for energizing the winding 51 to create an axial magnetic field. In this case, the face of the packing body 53, at which the outer connecting portion 542 is disposed, faces the driving circuit board 2, with the face preferably abutting the driving circuit board 2. However, said face can also be perpendicular to the driving circuit board 2 with the outer connecting portion 542 extending to the driving circuit board 2.

Referring back to FIG. 2 again, the number of the winding assemblies 5 used in the motor may be determined according to the phase number of the motor. For example, if the motor is a double-phased motor, two winding assemblies 5 may be detachably mounted on the driving circuit board 2. Similarly, if the motor is a triple-phased motor, three winding assemblies 5 may be detachably mounted on the driving circuit board 2. Furthermore, since the winding assemblies 5 are detachably mounted on the driving circuit board 2, when any one of the winding assemblies 5 is broken, only the broken one requires replacement rather then all the winding assemblies 5. Thus, this mechanism provides convenience in repairing the motor.

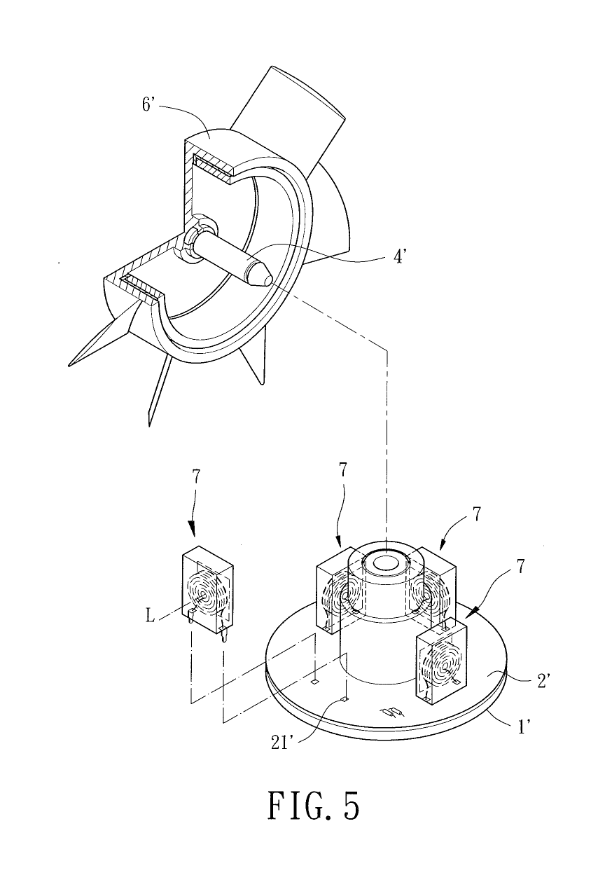

Referring to FIG. 5, an exploded perspective view of a radial gap type motor of a second embodiment is shown according to the preferred teachings of the present invention. The motor includes a motor base 1′, a driving circuit board 2′, a shaft tube 3′, a shaft 4′, a rotor 6′ and a plurality of winding assemblies 7. The driving circuit board 2′ is mounted on the motor base 1′. The shaft tube 3′ has one end coupled to the motor base 1′. The shaft 4′ is received in the shaft tube 3′. The winding assemblies 7 are detachably mounted on the driving circuit board 2′. Specifically, each winding assembly 7 is mounted on the driving circuit board 2′ through a pair of electrical connections 21′ of the driving circuit board 2′. The rotor 6′ is rotatably coupled to the shaft 4′.

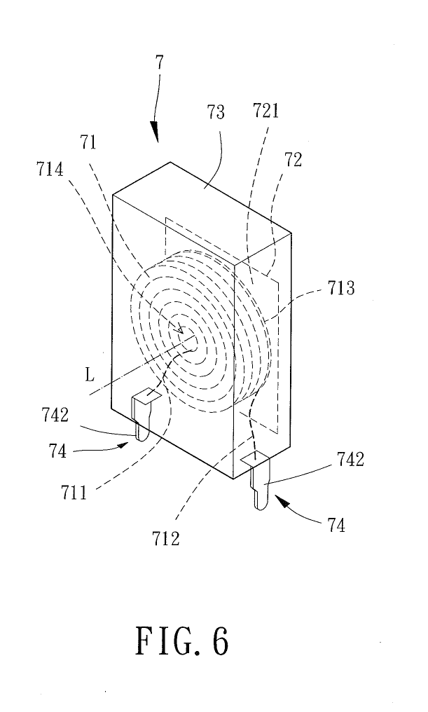

FIG. 6 shows a perspective view of the winding assembly 7 of the second embodiment according to the preferred teachings of the present invention. The winding assembly 7 also includes a winding 71, a base 72, a packaging body 73, and a pair of electrical connection members 74. The winding 71 also includes two ends 711 and 712, a plane 713, and a central hole 714. The base 72 also includes a supporting face 721 for intimate contact with the plane 713. The difference between the winding assembly 7 of the second embodiment and the winding assembly 5 of the first embodiment is that a face of the packing body 73, at which an outer connecting portion 742 is disposed, is perpendicular to the base 72. Thus, the winding assembly 7 of the second embodiment can be utilized on the radial gap type motor, allowing wider application of the motor assembly according to the preferred teachings of the present invention.

The outer connecting portions 742 of the electrical connection members 74 of the winding assembly 7 are connected with two electrical connections 21′ of the driving circuit board 2′ for energizing the winding 71 to create an axial magnetic field. In this case, a face of the packing body 73, at which the outer connecting portion 742 is disposed, faces the driving circuit board 2′, with the face preferably abutting the driving circuit board 2′. However, said face can also be perpendicular to the driving circuit board 2′ with the outer connecting portion 742 extending to the driving circuit board 2′.

Referring back to FIG. 5 again, the number of the winding assemblies 7 used in the motor may be determined according to the phase number of the motor. For example, if the motor is a double-phased motor, two winding assemblies 7 may be detachably mounted on the driving circuit board 2′. Similarly, if the motor is a triple-phased motor, three winding assemblies 7 may be detachably mounted on the driving circuit board 2′. Furthermore, since the winding assemblies 7 are detachably mounted on the driving circuit board 2′, when any one of the winding assemblies 7 is broken, only the broken one requires replacement rather then all the winding assemblies 7. Thus, this mechanism provides convenience in repairing the motor.

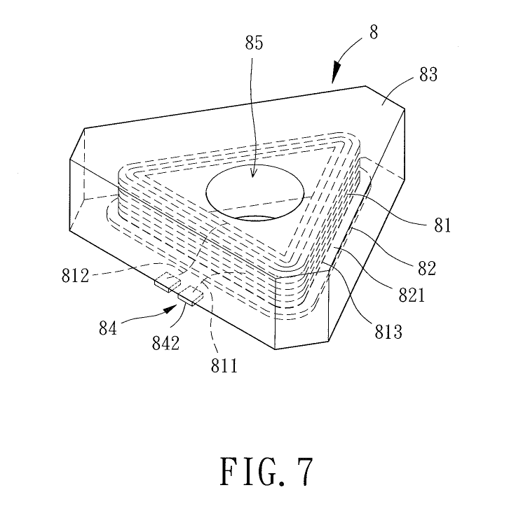

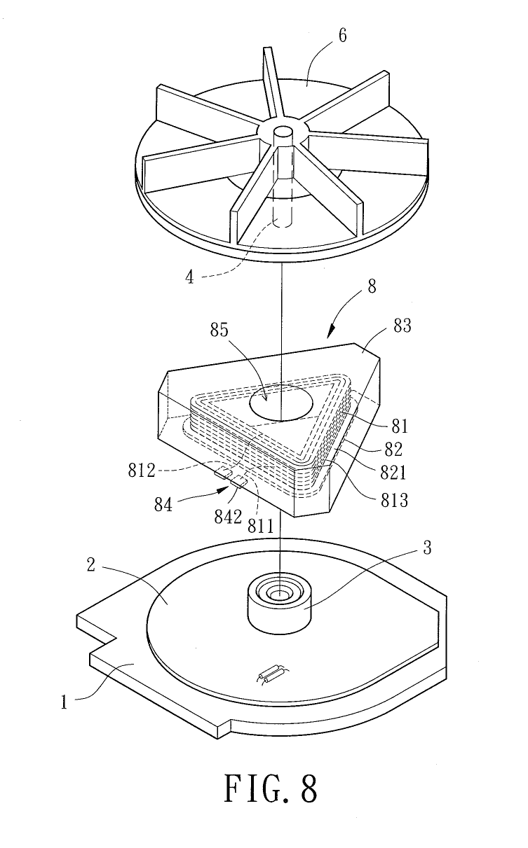

FIG. 7 shows a perspective view of a winding assembly 8 for a motor of a third embodiment according to the preferred teachings of the present invention. FIG. 8 shows an exploded view of an axial gap type motor utilizing the winding assembly 8 of FIG. 7. The motor includes a motor base 1, a driving circuit board 2, a shaft tube 3, a shaft 4, a rotor 6 and a winding assembly 8. The driving circuit board 2 is mounted on the motor base 1. The shaft tube 3 has one end coupled to the motor base 1. The shaft 4 is received in the shaft tube 3. The winding assembly 8 is detachably mounted on the driving circuit board 2. The rotor 6 is rotatably coupled to the shaft 4. The winding assembly 8 also includes a winding 81, a base 82, a packaging body 83, and a pair of electrical connection members 84. The winding 81 also includes two ends 811 and 812, and a plane 813. The base 82 also includes a supporting face 821 for intimate contact with the plane 813. The winding assembly 8 of the third embodiment is substantially the same as the winding assembly 5 of the first embodiment. The differences between the winding assembly 8 of the third embodiment and the winding assembly 5 of the first embodiment are that the winding 81 has triangular cross-sections and that the winding assembly 8 includes an assembling hole 85 allowing the winding assembly 8 to be easily mounted around the shaft tube 3 (FIG. 8) of the motor. The assembling hole 85 preferably extends throughout a center of the winding assembly 8. Specifically, the assembling hole 85 extends through the packaging body 83, the winding 81, and the base 82.

It can be appreciated that the winding assemblies 5, 7, and 8 according to the preferred teachings of the present invention provides assembling convenience and increases the yield rate of motors by packaging the winding 51, 71, 81 and the base 52, 72, 82 in a packaging body 53, 73, 83 while leaving exposed outer connecting portions 542, 742 and 842 for easy electrical connection and by providing readily perceivable marks indicating the positive and negative poles of the winding assemblies 5, 7, and 8.

While the principles of this invention have been disclosed in connection with specific embodiments, it should be understood by those skilled in the art that these descriptions are not intended to limit the scope of the invention, and that any modification and variation without departing the spirit of the invention is intended to be covered by the scope of this invention defined only by the appended claims.

What is claimed is:

1. A motor with detachable winding assemblies, comprising:
a motor base;
a shaft tube having one end coupled to the motor base;
a driving circuit board mounted on the motor base;
a shaft received in the shaft tube;
a plurality of winding assemblies detachably mounted on the driving circuit board, each comprising:
a base including a supporting face;
a winding including two ends and a plane, with the plane being in intimate contact with the support face of the base;
a packaging body enclosing the base and the winding; and
two electrical connection members respectively connected with the driving circuit board and the two ends of the winding, with each of the electrical connection members being partially exposed outside the packaging body; and
a rotor rotatably coupled to the shaft.

2. The motor with detachable winding assemblies as claimed in claim 1, with each of the two electrical connection members including an inner connecting portion in the packaging body and electrically connected to one of the two ends of the winding, and with each of the two electrical connection members further including an outer connecting portion disposed at a face of the packaging body.

3. The motor with detachable winding assemblies as claimed in claim 2, with the face, at which the outer connecting portion is disposed, being perpendicular or parallel to the base.

4. The motor with detachable winding assemblies as claimed in claim 3, with said face abutting a driving circuit board when the face is parallel to the base and the winding assembly electrically connects to said driving circuit board.

5. The motor with detachable winding assemblies as claimed in claim 1, with the winding further comprising a central hole extending therethrough and perpendicular to the plane of the winding.

6. A motor with detachable winding assembly comprising:
a motor base;
a shaft tube having one end coupled to the motor base;
a driving circuit board mounted on the motor base;
a shaft received in the shaft tube;
a winding assembly detachably mounted on the driving circuit board, comprising:
a base including a supporting face;
a winding including two ends and a plane, with the plane being in intimate contact with the support face of the base;
a packaging body enclosing the base and the winding;
two electrical connection members respectively connected with the driving circuit board and the two ends of the winding, with each of the electrical connection members being partially exposed outside the packaging body; and
an assembling hole extending through the winding, the base, and the packaging body and perpendicular to the support face of the base; and
a rotor rotatably coupled to the shaft.

7. The motor with detachable winding assembly as claimed in claim 6, with the assembling hole being in a center of the winding assembly.

8. The motor with detachable winding assembly as claimed in claim 6, with the winding assembly having triangular cross-sections.

9. The motor with detachable winding assembly as claimed in claim 6, with each of the two electrical connection members including an inner connecting portion in the packaging body and electrically connected to one of the two ends of the winding, and with each of the two electrical connection members including an outer connecting portion disposed at a face of the packaging body.

10. The motor with detachable winding assembly as claimed in claim 6, with the face, at which the outer connecting portion is disposed, being perpendicular or parallel to the base.
